(19) United States
(12) Patent Application Publication
(10) Pub. No.: US 2004/0131078 A1
(43) Pub. Date: Jul. 8, 2004

(54) Apparatus and method for supporting multiple wireless technologies within a device

(76) Inventors: Vivek G. Gupta, Portland, OR (US); Ernest E. Woodward, Chandler, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/336,234

(22) Filed: Jan. 3, 2003

(51) Int. Cl. H04J 3/22

(52) U.S. Cl. 370/466

(57) ABSTRACT

A communication device (200, FIG. 2) includes a connection manager (330, FIG. 3), which establishes and manages voice and data connections with various networks supported by the device. In response to a connection request from an application (302), the connection manager (330) selects a connection type based on the request preferences and information regarding the various possible available connections. The connection manager (330) then provides network isolation between the applications (302) and the protocol stack (222, FIG. 2) used to make the connection. The device is capable of concurrently supporting multiple connections for multiple applications (302) using multiple protocol stacks (222) and/or networks. Application developers can use a common interface to the connection manager (330), and thus an application does not need to be limited to using only specific protocol stacks.

### TECHNICAL FIELD

Embodiments of the invention relate generally to apparatus and methods for accessing data and network devices and, more particularly, to apparatus and methods making concurrent connections across heterogeneous wireless networks.

### BACKGROUND

A typical wireless device provides connectivity over one of a number of different types of networks. For example, a device could provide connectivity over a cellular network, a Bluetooth network or a network that supports an IEEE 802.11 standard. Each of these networks implements a different wireless airlink protocol, and devices that access each network generally use distinct types of hardware and software to support the various protocols. Accordingly, the networks are considered heterogeneous, meaning that the hardware and software associated with one of the network types cannot typically be used to make connections across another network type.

A user who wishes to access multiple ones of these different types of networks must have a separate device to support connectivity over each network. Unfortunately, this means that many users are required to carry multiple devices in order to meet their communication and data access needs. In an increasingly mobile society, managing multiple devices is increasingly undesirable. Transferring data from one network to another is also quite difficult.

### BRIEF DECSCRIPTION OF THE DRAWINGS

Embodiments of the invention are particularly pointed out and distinctly claimed in the concluding portion of the specification. However, embodiments of the invention, both as to organization and method of operation, together with objects, features, and advantages thereof, may best be understood by reference to the following detailed description when read with the accompanying drawings in which:

FIG. 1 is a simplified example of a communication system in which embodiments of the invention may be practiced;

FIG. 2 is a simplified block diagram of high-level connection processing subsystems within a client device, in accordance with an embodiment of the invention;

FIG. 3 is a more detailed block diagram of the application subsystem of FIG. 2, in accordance with an embodiment of the invention;

FIG. 4 is a more detailed block diagram of the communication subsystem of FIG. 2, in accordance with an embodiment of the invention; and

FIG. 5 illustrates a flowchart of a method for establishing a connection, in accordance with an embodiment of the invention.

### DETAILED DESCRIPTION

In the following detailed description, numerous specific details are set forth in order to provide a thorough understanding of embodiments of the invention. However, it will be understood by those skilled in the art, that embodiments of the invention may be practiced without these specific details. In other instances, well-known methods, procedures, components, and circuits have not been described in etail so as not to obscure the embodiments of the invention.

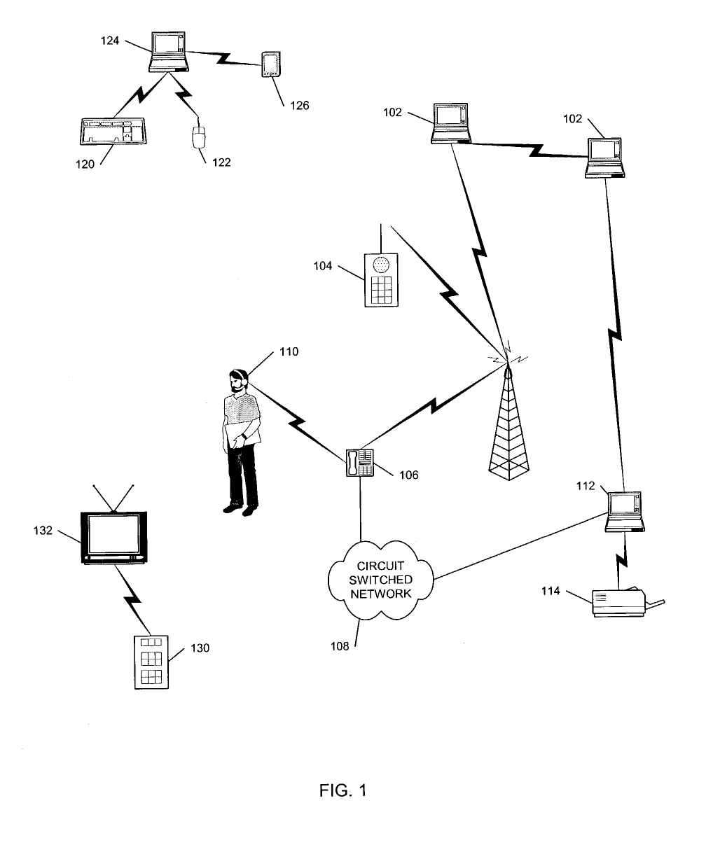

FIG. 1 illustrates a simplified example of a communication system in which embodiments of the invention can be practiced. The system includes one or more devices, which communicate over wired or wireless communication channels to one or more components of various systems or networks.

For example, the system could include various devices, such as laptop computers 102, which form part of a wireless local area network (WLAN), and which support an IEEE 802.11 standard (available at http://standards.ieee.org). The system also could include devices, such as cellular telephone 104 and stationary telephone 106, which are capable of communicating over a cellular network. In the case of stationary telephone 106, it could also support communications over a wired connection to a circuit switched network 108. Embodiments of the invention also could be implemented in devices that support a personal area network (PAN) protocol (e.g., a Bluetooth protocol such as that described in “Specification of the Bluetooth System”, version 1.1, Feb. 22, 2001, available at http://www.Bluetooth.com). A PAN device could be, for example, wireless telephone headset 110, portable or stationary computers 112, 124, printer 114, wireless keyboard 120 and mouse 122, and personal data assistant (PDA) 126. Bluetooth is a common wireless PAN technology, which can support wireless connections in a range of up to approximately 30 feet. Other Bluetooth revisions or PAN protocols also could be implemented in other embodiments.

In addition, devices 130 that support wireless communications with a television 132 could implement embodiments of the invention. Numerous other types of devices (not shown), which currently exist or that could be developed in the future, and which are capable of supporting the above-mentioned or other wired or wireless protocols, also could implement embodiments of the invention. Devices that communicate over wired communication channels could include hardware interfaces to those channels, and devices that communicate over wireless communication channels could include antennas (e.g., a dipole or other antenna) and/or other optical or radio frequency communication hardware.

In one embodiment, a single device, such as any of the devices described above, can establish connections with two or more heterogeneous wireless systems, where the word “heterogeneous” is meant to identify wireless systems that use different wireless technologies and/or protocols. Connections with the heterogeneous systems can occur at non-overlapping times, or can be concurrent, in one embodiment, as will be described in more detail later.

For example, in one embodiment, a device could communicate with one or more cellular networks, other Bluetooth devices, and/or networks in which an 802.11 protocol is implemented (e.g., a WLAN). In other embodiments, a device could communicate with a subset of the above systems, and/or with different types of systems or devices.

For the purposes of brevity, the below description illustrates an embodiment where cellular, Bluetooth, and 802.11 communications can be supported within a single device, which is referred to herein as a “client device.” It will be obvious to one of skill in the art, based on the description herein, how the below-described embodiments could be modified to support connectivity using other types of protocols.

As mentioned above, a device that is implemented in accordance with an embodiment of the invention can support one or more connections using a single protocol at a particular time, or it can simultaneously support connections using two or more heterogeneous protocols. For example, in one embodiment, a device such as computer 112 can access data services of a WLAN system, while simultaneously supporting a connection with a circuit switched network 108, and sending a command to a Bluetooth device (e.g., printer 114).

A client device, according to an embodiment of the invention, can implement one or more applications, which may include, but are not limited to, voice applications, telephony, network browser applications, video streaming, messaging, synchronization applications, or other applications (e.g., printing, file transfer, etc.). In one embodiment, the client device is able to provide each of the various applications with the ability to communicate using different technology protocols, without requiring each application to interface directly with the various protocol stacks.

Specifically, an embodiment of the invention provides a level of abstraction between the applications and the protocol stacks, as will be described in more detail, below. Accordingly, application developers can use a common interface to components within the client device that manage connectivity using a variety of wireless communication protocols. This allows application developers to develop programs that are portable to different platforms, such as moving to a new or different cellular technology, for example.

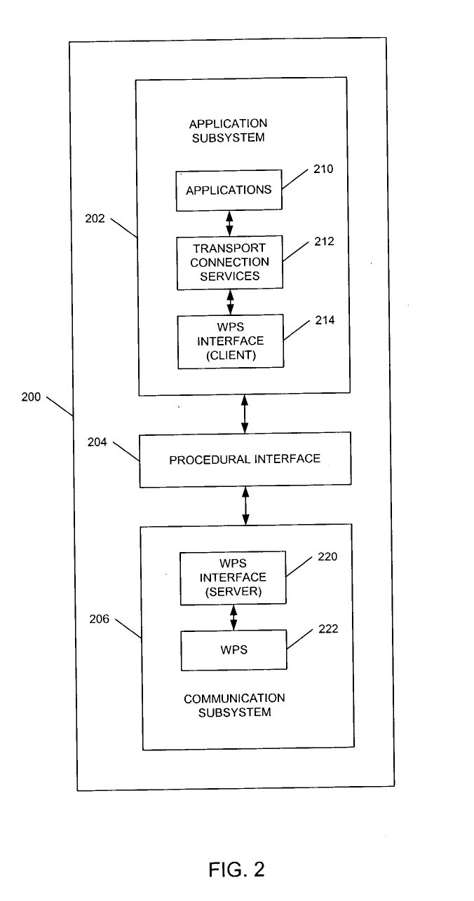

FIG. 2 is a simplified block diagram of high-level connection processing subsystems within a client device, in accordance with an embodiment of the invention. In one embodiment, client device 200 includes an application subsystem 202, a communication subsystem 206, and a procedural interface 204 between the application and communication subsystems.

Application subsystem 202 includes various applications, and provides the ability for those applications to connect with one or more supported networks. The applications can write to and read from a generic interface. Transport connection services within the application subsystem 202 provide a level of abstraction between the applications and the various wireless protocol stacks that are specific to the networks that are supported by the device.

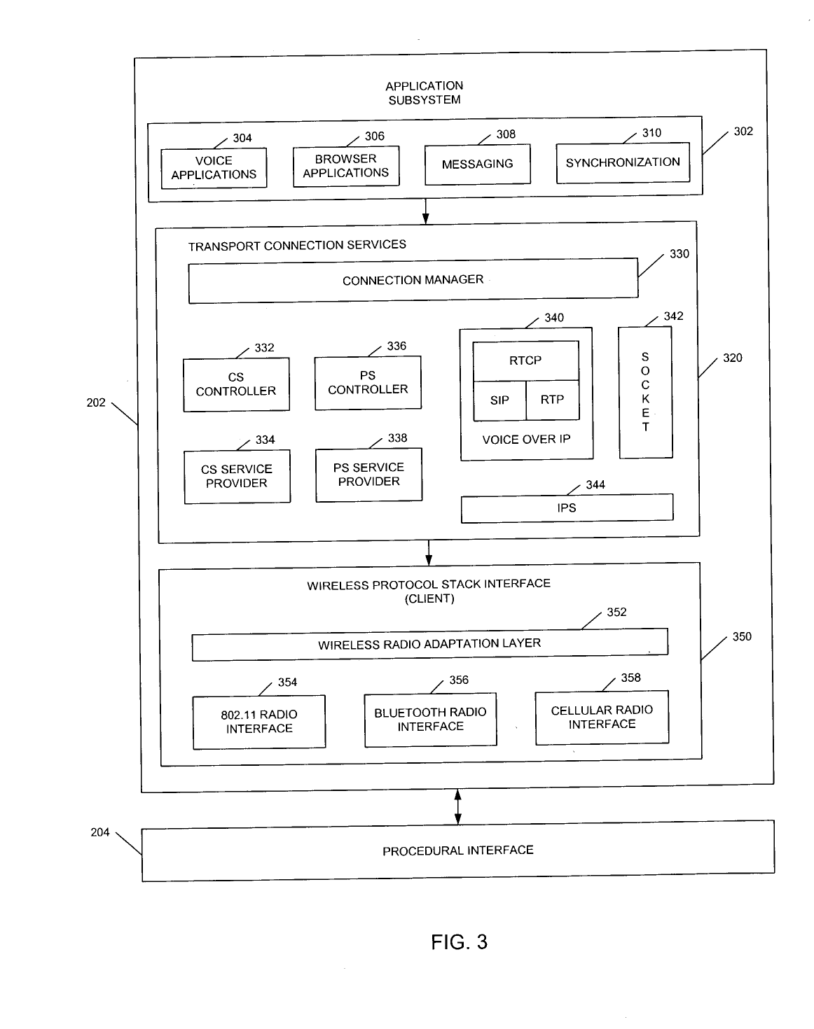

In one embodiment, application subsystem 202 includes one or more applications 210, Transport Connection Services (TCS) 212, and a client-side wireless protocol stack (WPS) interface 214. Each of these components is described in much more detail in conjunction with FIG. 3. Briefly, the applications block 210 includes one or more voice and/or data applications, which rely on network connections to send information from the client device to various networks, and also to receive information from the networks.

The TCS block 212 provides a consistent programming view of communication functionality to the applications 210, while they are running. TCS 212 allows applications to make connections over the various networks (e.g., cellular, 802.11, and Bluetooth), and to transfer voice and data using these connections. In one embodiment, TCS 212 provides support for applications by providing connection management, call control, and data transfer functionality. In one embodiment, TCS 212 also incorporates the Internet Protocol Suite (IPS), which is used for sending data over IP networks.

In one embodiment, TCS 212 provides a layer of abstraction for making voice and data connections to various networks. The transport connection services are discussed in substantially more detail in conjunction with FIG. 3.

TCS 212 gains access to the WPS 222 by making requests to the client-side WPS interface 214. The client-side WPS interface 214 communicates with the communication subsystem 206 over the procedural interface 204.

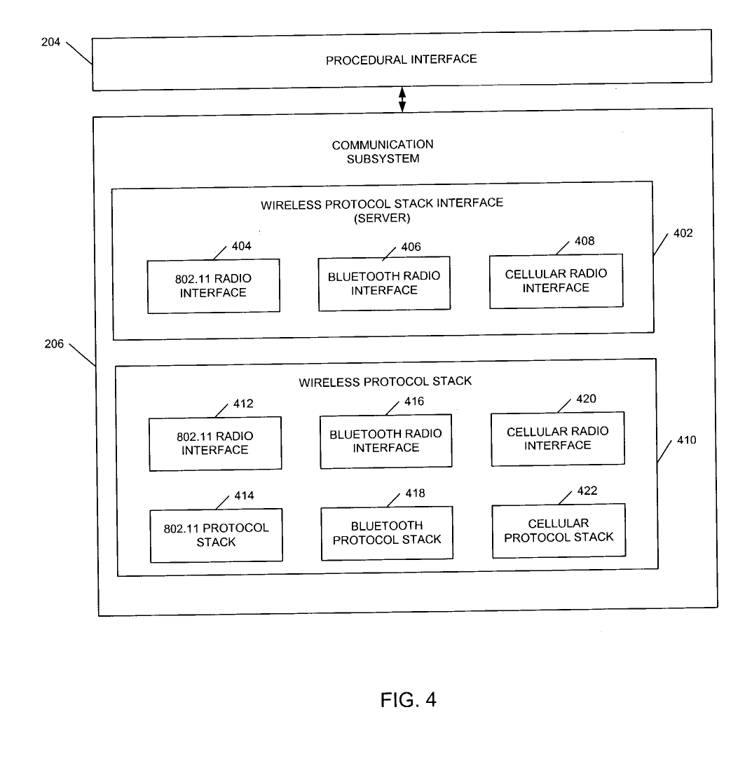

Communication subsystem 206 handles the details of different interfaces exposed by the various communication protocols. In one embodiment, communication subsystem 206 includes a server-side WPS interface 220, and the WPS 222 for each of the various supported protocols. Each of these components is described in much more detail in conjunction with FIG. 4. Briefly, server-side WPS interface 220 communicates with the client-side WPS interface 220 over the procedural interface 204.

Procedural interface 204 serves as the interface between the application subsystem 202 and the communication subsystem 206. Separation of the application and communication subsystems 202, 206 using the procedural interface 204 is performed, in one embodiment, to comply with the premise of independent applications and communications.

In one embodiment, application subsystem 202 and communication subsystem 206 are implemented on separate processors or using separate control logic. In this “two-chip” architecture, procedural interface 204 is supported over a hardware interconnect. For example, the hardware interface could be a bus (e.g., PCI, USB, firewire, etc.), a unique or proprietary hardware interconnect. In another embodiment, application subsystem 202 and communication subsystem 206 can be implemented on the same processor or using the same control logic. In this “one-chip” architecture, procedural interface 204 could be implemented over shared, partitioned memory.

FIG. 3 is a more detailed block diagram of the application subsystem 202 (FIG. 2), in accordance with an embodiment of the invention. In one embodiment, application subsystem 202 includes applications 302, connection manager 330, transport connection services 320, and a client-side WPS interface 350. As described previously, application subsystem 202 communicates with the communication subsystem (206, FIG. 2) over procedural interface 204.

Applications block 302 can include from one to many different types of voice and/or data applications that rely on connections with various networks. For example, but not by way of limitations, applications block 302 could include voice applications 304, browser applications 306, messaging 308, synchronization 310, or other applications (e.g., telephony, video streaming, printing, file transfer, cellular data services such as messaging services, multimedia messaging services, etc.). In one embodiment, the applications within applications block 302 can be written with a common interface, without regard to the particular network protocols for the networks that the application data could be sent over.

In one embodiment, transport connection services 320 basically help applications 302 establish and configure connections using the connection manager 330. Connection manager 330 helps in the establishment and management of both voice and data connections with the various networks supported by a device. In one embodiment, connection manager 330 is capable of:

1) Providing network isolation between the applications 302 and the protocol stacks used to make connections.

2) Selecting the appropriate core network (e.g., circuit switched or packet switched) for a connection requested by an application.

3) Supporting different types of connections in a concurrent manner. For example, in one embodiment, a client device (e.g., a cell phone, handheld PDA, or other handheld device) can make connections over multiple different types of wireless networks. Accordingly, a device can be making a phone call, accessing enterprise data using 802.11, or communicating with another Bluetooth device in a concurrent fashion.

4) Providing resource management. In one embodiment, the connection manager 330 can implement algorithms to decide which way the resources should be allocated. For example, prioritized voice-quality traffic can be given the appropriate resources in balance with the needs of lower-rated traffic.

5) Keeping track of connections, and adjusting their properties when appropriate (e.g., disconnecting idle connections, or tearing down existing connections to bring up new connections).

6) Allowing users to configure connections and set policies.

Connection manager 330 supports connections over various core networks (e.g., packet switched networks (IP based) and circuit switched networks (e.g., PSTN)). In one embodiment, connection manager 330 abstracts connection knowledge from applications, and isolates the applications from the various underlying technologies.

For example, in the cellular domain, the connection manager 330 can help to make seamless connections across radio access networks (RANs) or a core network (CN). RAN is a cellular wireless technology used to deliver various services, such as GPRS, W-CDMA, and others. A CN is an intermediate network used by the cellular wireless provider to access the public network on which the far-end host of the communication session resides. These include circuit switched and packet switched networks, among others.

In the 802.11 domain, the connection manager 330 is charged with establishing and releasing all of the data-link-established-contexts through its association with a PSSP 338, described later, associated with the 802.11 technology. Control of the data-link-established-contexts is not passed to the applications 302, in one embodiment. In contrast, the voice-link-established-contexts are controlled by the applications, themselves, in accordance with an embodiment.

In some cases, connection manager 330 may abstract the details of the connection technologies for a more simplified use by the applications 302. For example, connection manager 330 may select the voice-link-established-contexts of 802.11 communications for the appropriately matched Quality of Service (QoS) levels on a voice-connection request from an application. In addition, connection manager 330 may select the data-link-established-contexts of 802.11 communications for the appropriately matched QoS levels on a data connection request from an application.

The connection manager 330 can provide support for both voice and data connections across both wired and wireless networks, in one embodiment. This could include, for example, support for LAN connections over Ethernet, WLAN connections using an 802.11 standard, as well as wireless WAN connections using cellular networks. In one embodiment, the connection manager can support both local and remote connections using well-known techniques, such as Remote Access Server (RAS) and the Point-to-Point Tunneling Protocol (PPTP) techniques, for example.

Connection manager 330 supports connections across various types of networks, and is responsible for providing connections from a source network to a destination network. The connection manager 330 supports several network points of attachments, in one embodiment, and has complete knowledge of all network elements involved in a connection. Thus, in one embodiment, connection manager 330 has all the routing information about a particular data connection. In other words, connection manager 330 knows whether a particular connection has been routed over an 802.11 network, a cellular network or Ethernet. This knowledge allows connection manager 330 to determine boundaries between various networks, and allows it to switch connections to the most appropriate network at any time.

In one embodiment, connection manager 330 includes a connection policy manager, which allows a user to indicate his or her preferences for making connections for various applications. Based on these preferences, the connection policy manager selects a network and handles the details of the connection (e.g., selecting between circuit switched or packet switched networks, or between WLAN or cellular, etc.).

In an alternate embodiment, connection manager 330 is not included in application subsystem 202. Instead, applications 302 might be required to directly call core operating system services and manage the burden of handling connections. In an alternate embodiment, applications 302 can rely on HTTP/FTP or WAP interfaces.

In one embodiment, connection manager 330 decides which of a variety of supported networks a particular application 302 will use, or provides information that allows the application to make an appropriate selection for making a network connection. For example, but not by way of limitation, connection manager 330 could choose a circuit switched (CS) network, a packet switched (PS) network, a network supporting voice over IP (VoIP), a sockets interface, or a network implementing an internet protocol.

Transport connection services block 320 includes various functional blocks for handling connections over the various networks. For example, regarding CS networks, TCS 320 includes a CS controller 332 and a CS Service Provider (CSSP) 334. For PS networks, TCS 320 includes a PS controller 336 and a PS Service Provider (PSSP) 338. In addition, TCS 320 includes connection support for VoIP 340, and data services such as sockets 342 and the Internet Protocol Suite (IPS) 344, which includes commonly used Internet protocols, such as TCP/UDP/IP, and PPP (Point-to-Point Protocol). Each of these blocks is discussed briefly, below.

CS controller 332 is used in conjunction with CSSP 334 (and with other components, described later) to support circuit switched connections. CS controller 332 and CSSP 334 are used to isolate applications 302 from changes in underlying network infrastructure. This isolation is desirable, because multiple devices in a system can provide support for CS-based voice and data connections. These devices, in turn, can use multiple communication protocols over different networks for this purpose.

CS connections can be used for transferring either or both voice and data. Using a CS connection, network resources are allocated for the duration of the connection.

CS controller 332 abstracts call control functionality to allow different and seemingly incompatible communication protocols to expose a common interface to applications 302. As such, in one embodiment, a single instance of CS controller 332 exists in the system. CS controller 332 manages all CS devices that provide a telephone interface or that transmit CS data over CS connections.

In one embodiment, CS controller 332 deals primarily with the control portion of CS connections. The CS controller 332 also regulates concurrent access to CS devices from multiple applications 302. The CS controller 332 depends on CSSP 334 for supporting the wide variety of devices that could be using new and evolving communication protocols. CS controller 332 provides a common interface for all CSSPs 334.

CSSP 334 encapsulates the telephony and call control functionality for a specific communication protocol in a network. As such, in the case of a cellular network, for example, a separate CSSP 334 is provided for each of the wireless cellular protocols (e.g., GSM, W-CDMA, etc.).

The system includes a CSSP 334 for every device that it supports, in one embodiment. CSSP 334 handles device-specific controls for communications programming. In one embodiment, CSSP 334 conforms to the interface specified by CS controller 332, in order to function as a service provider within the telephony environment. In one embodiment, CSSP 334 is also responsible for setting the routing of information in the user plane.

For voice routing, as an example, CSSP 334 establishes the voice signal routing using the services of an audio driver (not shown), which interfaces with a speaker and microphone. When the audio codec is on the application subsystem 202, the audio driver retrieves the digital audio samples from the microphone. These samples are then packetized and transferred over the procedural interface 204 using the wireless radio adaptation layer 352 and a wireless client interface (e.g., interfaces 354, 356, 358) in the client-side WPS interface 350, which will be described in more detail, later. In addition, in one embodiment, CSSP 334 may use the services of the audio driver in adjusting volume amplification of the speaker.

PS controller 336 is used in conjunction with PSSP 338 (and with other components, described later) to support packet switched connections. PS controller 336 and PSSP 338 are also used to isolate applications 302 from changes in underlying network infrastructure. Again, this isolation is desirable, because multiple devices in a system can provide support for PS-based voice and data connections. These devices, in turn, can use multiple communication protocols over different networks for this purpose.

PS connections are network connections used primarily for the purpose of transferring data. They can be used for transferring voice, as well, using VoIP. Using a PS connection, network resources may or may not be allocated for the duration of the connection, depending on the QoS requirements. A PS connection can be shared by multiple applications at the same time.

PS controller 336 abstracts call control functionality to allow different and seemingly incompatible communication protocols to expose a common interface to applications 302. As such, in one embodiment, a single instance of PS controller 336 exists in the system. PS controller 336 manages all PS devices that transmit PS data over PS connections.

In one embodiment, PS controller 336 deals primarily with the control portion of PS connections. The PS controller 336 also regulates concurrent access to PS devices from multiple applications 302. The PS controller 336 depends on PSSP 338 for supporting the wide variety of devices that could be using new and evolving communication protocols. PS controller 336 provides a common interface for all PSSPs 338.

PSSP 338 is concerned with control aspects of PS connections. The services provide by the PSSP 338 primarily involve the establishment and/or release of packet-based connections (e.g., either as data-link-established-contexts or voice-link-established-contexts). One of the main roles of the PSSP 338 is to abstract the details of the device technologies on behalf of the applications. In other words, PSSP 338 abstracts the device and the underlying wireless technology, and helps in creating and controlling PS connections. In the case of GPRS, for example, PSSP 338 can use PDP contexts to establish a logical tunnel with GSSN, and control it.

In one embodiment, PSSP 338 is controlled by connection manager 330, and does not provide interfaces to the applications. Because of this, in some cases, there is no need for a PS controller 336, as there is in the CS case, where multiple applications may have access to establish and control CS network connections.

In one embodiment, PSSP 338 is also responsible for setting the routes of data traffic in the user plane. The exact functionality is system dependent.

The system includes a PSSP 338 for every technology that it supports, in one embodiment. For example a PSSP 338 for 802.11 technologies is defined in terms of an 802.11 PSSP.

In one embodiment, processing Voice over IP (VOIP) connections is performed using VoIP block 340. VoIP block 340 uses several protocols to provide a common VoIP interface to applications 302, and to control VoIP connections. These may include, for example, Session Initiation Protocol (SIP), Real Time transfer Protocol (RTP), and Real Time Control Protocol (RTCP). Each of these protocols is discussed briefly, below.

SIP is a standard that provides call control services by helping to establish IP telephony connections and packetizing audio. SIP is a client-server protocol (based on HTTP), in which requests are issued by a calling client, and responded to by a called server. SIP uses many of the message types and header fields of HTTP, identifying the contents of an information stream with entity headers, and allowing for authentication using methods similar to those used on the Web. Alternatively, the H.323 protocol could be used instead of or in addition to SIP.

In one embodiment, SIP defines setup and connect type messages, which define the process of opening a reliable channel over which call control messages may be passed. This channel does not depend on TCP for reliability, but handles its own acknowledgement and handshaking.

RTP provides a number of services, which help in delivery of real time voice and video streams. RTP defines frame structures and handles synchronization issues. RTP helps to bring some regularity and predictability to applications that use the Internet for transporting time-sensitive traffic. Some of the features of RTP include timestamping, sequence numbering, delivery monitoring, and payload identification.

RTCP helps in managing the quality of voice on networks. RTCP is used for connection quality control, bandwidth control, and status information transfers. RTCP provides information, which can be used by network service providers to adjust priorities, queuing or even routing packets to stay within tolerances imposed by service level agreements with a customer.

In one embodiment, the transport connection services block 320 also includes support for sockets 342 and IPS 344, which allow applications 302 to send data across various types of network connections. Each is described briefly, below.

Sockets 342 is an interface, which may be used to discover and utilize the communications capabilities of any number of underlying transport protocols. Sockets is not a protocol. Accordingly, sockets does not affect the bits on the wire, and does not need to be utilized on both ends of a communications link.

Sockets can be used to provide a protocol-independent interface, fully capable of supporting emerging networking capabilities, such as real-time multimedia communications. Sockets interface 342 can be connectionless or connection-oriented. Connectionless protocols may use datagram type sockets, and connection-oriented protocols may use stream type sockets.

Sockets programming has previously centered on TCP/IP. In one embodiment, however, sockets is implemented in a manner that it is able to provide support for multiple protocol stacks. Accordingly, in one embodiment, the sockets interface 342 is separate from the protocol stack (e.g., WPS 222, FIG. 2), and a standard interface is provided between sockets 342 and the protocol stack. In one embodiment, support for RFCOMM protocol has been added to sockets 342, in order to provide access to PAN (e.g., Bluetooth) capabilities through the sockets interface 342. RFCOMM is a protocol specific to Bluetooth. Other technologies could use protocols similar to RFCOMM.

IPS 344, in one embodiment, includes commonly used Internet protocols, such as TCP/UDP/IP, and PPP (Point-to-Point Protocol), for example. PPP provides a method for transmitting datagrams over serial point-to-point links.

In one embodiment, a device can simultaneously support multiple connections of the same or different types. For example, in the cellular domain, the device could support multiple PS connections, which could use multiple PDP contexts. In one embodiment, packets generated by IP stack and PPP modules are mapped to the appropriate PDP context using a PS mapping process, which can be implemented as part of the transport connection services 320, or as part of the IP stack.

Besides the above described transport connection services 320, additional or different services could be provided within a client device. The specific descriptions of the various types of connections, above, is not meant to limit the scope of the invention to devices supporting only these connection types, or the combination of connection types described. Those of skill in the art would understand, based on the description herein, that transport connection services 320 could be used to abstract protocol stacks for other types of systems and connections.

Transport connection services block 320 is operationally connected to client-side WPS interface 350. Client-side WPS interface 350 translates interfaces to modules included in transport connection services 320 to specific interfaces supported by various wireless systems (e.g., 802.11, Bluetooth, and cellular systems). In one embodiment, client-side WPS interface 350 includes wireless radio adaptation layer (WRAL) 352, and a variety of network dependent client interfaces, such as, for example, 802.11 radio interface 354, Bluetooth radio interface 356, and cellular radio interface 358. In alternate embodiments, more or different interfaces could be included.

WRAL 352 provides translation from operating system specific definitions of the various protocol interfaces 354, 356, 358. The 802.11, Bluetooth, and cellular subsystems each could support various different protocols. However, different operating systems may isolate the different modules in the transport connection services block 320 from the various protocols. Operating systems accomplish this, in one embodiment, by providing their own definition for the various protocol interfaces. For example, sometimes this definition is as simple as the “AT command” interface, as described in the Third Generation Partnership Proposal Technical Specification (“3GPP Standard”). In other cases, it can be more complex and involved. Basically, the WRAL 352 enables other transport connection service modules to be developed independently of the details of the various interfaces.

In one embodiment, WRAL 352 includes an adaptation module for each type of supported technology. For example WRAL 352 can include a cellular interface adaptation module, which provides translation from operating system specific definitions of wireless protocol interfaces (e.g., interfaces 354, 356, 358) to common interfaces. An 802.11 interface adaptation module maps to standard 802.11 interface services. Finally, a Bluetooth interface adaptation module can map to services of the Host Controller Interface (HCI).

The 802.11 radio interface 354, Bluetooth radio interface 356, and cellular radio interface 358 each provide their respective interfaces to the rest of the transport connection services 320. For example, the 802.11 radio interface 354 acts as a proxy of the actual 802.11 subsystem, and implements a separation of the application subsystem 202 and the communication subsystem 206 (FIG. 2).

Another separation of the application subsystem 202 and the communication subsystem 206 is achieved over the procedural interface 204. Referring also to FIG. 4, each client-side radio interface 354, 356, 358 (FIG. 3) communicates with a corresponding server-side radio interface 404, 406, 408, within the server-side WPS interface 402. The client and server pass function calls and responses across the procedural interface 204.

FIG. 4 is a more detailed block diagram of the communication subsystem 206 (FIG. 2), in accordance with an embodiment of the invention. Communication subsystem 206 includes server-side WPS interface 402 and WPS 410, in one embodiment. As described in the preceding paragraph, the various server-side radio interfaces 404, 406, 408 communicate with corresponding client-side radio interfaces 354, 356, 358 (FIG. 3) within the application subsystem 202.

Associated with each of the server-side radio interfaces 404, 406, 408 is a corresponding protocol stack 414, 418, 422 within WPS 410. WPS 410 provides the core services for each of the various technologies. Each technology supported in WPS 410 includes a radio interface 412, 416, 420 and the actual protocol stacks 414, 418, 422. Each protocol stack 414, 418, 422 is responsible for applying the appropriate data formatting, performing various connection establishment procedures, and sending data over the air interface.

A detailed discussion of various types of protocol stacks, and how they are implemented is outside the scope of the invention. Briefly, the 802.11 protocol stack 414 includes link layer control, and also the MAC and PHY layers. The Bluetooth protocol stack 418 supports HCI services and includes a link manager. The cellular protocol stack 422 interfaces over the air with GSM, GPRS, and W-CDMA networks, for example.

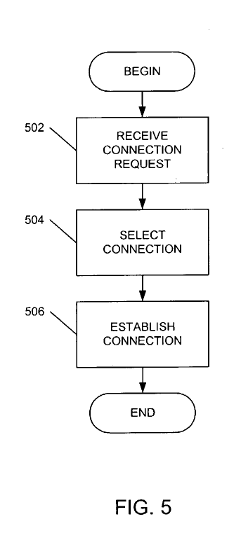

FIG. 5 illustrates a flowchart of a method for establishing a connection, in accordance with an embodiment of the invention. The method begins, in block 502, when the connection manager (e.g., connection manager 330, FIG. 3) receives a request from an application (e.g., application 304, 306, 308, 310) to establish a connection.

In one embodiment, a connection request may include the identity of the destination, and also one or more preferences regarding the requested connection. For example, preferences can include, but are not limited to:

1) Cost - applications 302 can specify their intent to select the connections based on cost of connection;

2) Bandwidth - applications 302 can specify the maximum/minimum bandwidth they need for their connections;

3) Latency - this indicates the round-trip time for a request originating from the client device to traverse through the selected network and reach the server, and then for the client device to receive a reply. Certain wireless protocols (e.g., Cellular Digital Packet Data (CDPD)) have lower network latencies than others (e.g., GSM/GPRS);

4) Exclusiveness - if a connection is non-exclusive, it can be shared among all applications;

5) Time period/connection duration - connections can be persistent or they can be for a specified time period; and

6) Priority/Quality of Service (QoS) parameters - this allows applications 302 to specify a QoS class (e.g., as used in 3GPP) and/or specific QoS factors, such as maximum bit rate, guaranteed bit rate, allowed transfer delay, and whether the requested QoS class is negotiable or not.

For example, regarding the QoS class, the data services in cellular networks can be characterized by the QoS they offer. QoS classes include a conversational class, a streaming class, an interactive class, and a background class, each of which have different characteristics regarding delays, buffering, whether or not traffic is symmetric or asymmetric, and whether or not the bit rate is guaranteed. The main distinguishing factor between different QoS classes is how delay sensitive the traffic is.

In block 504, the connection manager selects a connection. In one embodiment, the connection manager includes a connection policy manager, which selects the connection based on the request preferences and information regarding the various possible available connections. Information regarding the different types of networks available is provided to the connection manager from the various WPSs (e.g., WPSs 410, FIG. 4), in one embodiment. In addition, in one embodiment, the communication subsystem 206 (FIG. 2) provides information about the various radio access networks it supports.

In one embodiment, the connection policy manager first enumerates all of the possible connections. The connection policy manager then associates a set of parameters with these connections, and ultimately determines the optimal connection based on a variety of factors and the preferences specified in the request, if any.

After a connection is selected, then in block 506, a connection is established. In one embodiment, the various modules and abstraction characteristics of the transport connection services 320 (FIG. 3) are utilized as described in detail above, in order to provide the appropriate connection. In addition, depending on the selected technology (e.g., 802.11, Bluetooth, cellular, etc.), the various modules of the client-side and server-side WPSs 214, 220 (FIG. 2) and the appropriate WPS 222, itself, are implemented to establish and support the connection.

After establishment of the connection, the connection establishment procedure ends. While the connection exists, the connection manager has access to all the routing information regarding a particular data connection, in one embodiment. For example, the connection manager knows whether a particular connection has been routed over 802.11, Ethernet, or a cellular network. This knowledge allows the connection manager to determine boundaries between various networks, and allows it to switch connections to the most appropriate network at all times.

The embodiments above describe a system that supports various cellular protocols (e.g., GSM/GPRS and W-CDMA), wireless LAN protocols (e.g., IEEE Std. 802.11 and its various derivatives), and wireless PAN protocols (e.g., Bluetooth). The scope of the invention is not intended to be limited to these protocols. Instead, as would be obvious to one of skill in the art based on the description herein, other wired or wireless protocols could be similarly supported by modifying or including various modules.

The functions of the various embodiments can be practiced within a wide variety of computers, devices, and other electronic systems. The computer, device, or system could include one or more microprocessors, power supplies, storage media, interfaces to outside networks, and user interfaces.

Besides executing the various embodiments on a computer, device, or other system, a program of instructions executable by a machine to perform the methods of the various embodiments could be stored on one or more machine-readable program storage devices or computer-readable media. For example, such machine-executable instructions can be stored on RAM, ROM, hard drive, CD, magnetic disk, disk drive, a combination of these types of storage media, and/or other types of storage media that are known to those of skill in the art.

Thus, embodiments of an apparatus and method for supporting multiple wireless technologies within a device have been described. Embodiments of the invention may be used in wired or wireless devices, such as cable modems, cellular or landline telephones, network interfaces, pagers, wired or wireless LAN devices, and many other types of devices.

The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, it is to be understood that the appended claims are intended to cover all such alternatives, modifications, equivalents and variations as fall within the spirit of the invention.

What is claimed is:

1. A method performed in a first device comprising:
establishing a first connection between a first destination device and a first application program executing on the first device, using a first protocol of multiple communication protocols that are supported by the first device and are potentially available to the first application;
formatting first application data produced by the first application to create first formatted data that is consistent with a first interface to a first protocol stack associated with the first protocol, using a formatting procedure that is separate from the first application; and
providing the first formatted data to the first interface.

2. The method of claim 1, further comprising:
establishing, while the first connection still exists, a second connection between a second destination device and a second application program executing on the first device, using a second protocol supported by the first device;
formatting second application data produced by the second application to create second formatted data that is consistent with a second interface to a second protocol stack associated with the second protocol; and
providing the second formatted data to the second interface.

3. The method of claim 1, further comprising:
establishing, while the first connection still exists, a second connection between a second destination device and a second application program executing on the first device, using the first protocol;
formatting second application data produced by the second application to create second formatted data that is consistent with the first interface to the first protocol stack; and
providing the second formatted data to the first interface.

4. The method of claim 1, further comprising:
establishing a second connection between a second destination device and the first application program, using a second protocol supported by the first device;
formatting second application data produced by the first application to create formatted data that is consistent with a second interface to a second protocol stack associated with the second protocol, wherein the first protocol and the second protocol are heterogeneous; and
providing the second formatted data to the second interface.

5. The method of claim 1, wherein the first protocol is a wireless communication protocol.

6. The method of claim 5, wherein the first protocol is a protocol from a group of protocols that includes an IEEE 802.11 standard protocol, a personal area network protocol, and a cellular network protocol.

7. The method of claim 1, further comprising:
receiving, from the first application program, a request to establish the first connection; and
selecting the first protocol based on information included in the request.

8. The method of claim 7, wherein the information included in the request includes one or more preferences regarding characteristics associated with the first protocol.

9. The method of claim 8, wherein the one or more preferences is one or more preferences from a group of preferences that includes cost, bandwidth, latency, exclusiveness, connection duration, priority, and quality of service.

10. The method of claim 7, wherein selecting the first protocol is also based on information regarding the different types of networks available.

11. An apparatus comprising:
means for establishing a first connection between a first destination device and a first application program executing on the first device, using a first protocol of multiple communication protocols that are supported by the first device and are potentially available to the first application;
means for formatting first application data produced by the first application to create first formatted data that is consistent with a first interface to a first protocol stack associated with the first protocol, using a formatting procedure that is separate from the first application; and
means for providing the first formatted data to the first interface.

12. The apparatus of claim 11, further comprising:
means for establishing, while the first connection still exists, a second connection between a second destination device and a second application program executing on the first device, using a second protocol supported by the first device;
means for formatting second application data produced by the second application to create second formatted data that is consistent with a second interface to a second protocol stack associated with the second protocol; and
means for providing the second formatted data to the second interface.

13. The apparatus of claim 11, further comprising:
means for receiving, from the first application program, a request to establish the first connection; and
means for selecting the first protocol based on information included in the request.

14. An apparatus comprising:
first control logic, that
establishes a first connection between a first destination device and a first application program executing on the first device, using a first protocol of multiple communication protocols that are supported by the first device and are potentially available to the first application,
formats first application data produced by the first application to create first formatted data that is consistent with a first interface to a first protocol stack associated with the first protocol, using a formatting procedure that is separate from the first application, and
provides the first formatted data to the first interface.

15. The apparatus of claim 14, wherein the first control logic further:
establishes, while the first connection still exists, a second connection between a second destination device and a second application program executing on the first device, using a second protocol supported by the first device,
formats second application data produced by the second application to create second formatted data that is consistent with a second interface to a second protocol stack associated with the second protocol, and
provides the second formatted data to the second interface.

16. The apparatus of claim 14, wherein the first control logic further:
receives, from the first application program, a request to establish the first connection, and
selects the first protocol based on information included in the request.

17. The apparatus of claim 14, further comprising:
a procedural interface, coupled to the first control logic, over which messages between the first control logic and the first protocol stack are exchanged.

18. The apparatus of claim 17, wherein the procedural interface is a memory device.

19. The apparatus of claim 17, wherein the procedural interface is a hardware interconnect.

20. A system comprising:
a communication channel operably connected to a source device and a destination device;
the source device having first control logic, that
establishes a first connection between a destination device and a first application program executing on the source device, using a first protocol of multiple communication protocols that are supported by the source device and are potentially available to the first application,
formats first application data produced by the first application to create first formatted data that is consistent with a first interface to a first protocol stack associated with the first protocol, using a formatting procedure that is separate from the first application, and
provides the first formatted data to the first interface; and
the destination device, that receives the first formatted data over the first connection.

21. The system of claim 20, wherein the first control logic further:
receives, from the first application program, a request to establish the first connection, and
selects the first protocol based on information included in the request.

22. The system of claim 20, further comprising:
a procedural interface, coupled to the first control logic, over which messages between the first control logic and the first protocol stack are exchanged.

23. The system of claim 20, wherein the communication channel is a wireless communication channel, and the source device further includes a dipole antenna for sending the first formatted data over the wireless communication channel.

24. The system of claim 20, wherein the communication channel is a wired communication channel, and the source device further includes an interface for sending the first formatted data over the wired communication channel.

25. A program storage device readable by a machine, tangibly embodying a program of instructions executable by the machine to perform a method for supporting a connection, the method comprising:
establishing a first connection between a first destination device and a first application program executing on the first device, using a first protocol of multiple communication protocols that are supported by the first device and are potentially available to the first application;
formatting first application data produced by the first application to create first formatted data that is consistent with a first interface to a first protocol stack associated with the first protocol, using a formatting procedure that is separate from the first application; and
providing the first formatted data to the first interface.

26. The program storage device of claim 25, wherein the method further comprises:
establishing, while the first connection still exists, a second connection between a second destination device and a second application program executing on the first device, using a second protocol supported by the first device;
formatting second application data produced by the second application to create second formatted data that is consistent with a second interface to a second protocol stack associated with the second protocol; and
providing the second formatted data to the second interface.

27. The program storage device of claim 25, wherein the method further comprises:
receiving, from the first application program, a request to establish the first connection; and
selecting the first protocol based on information included in the request.
